(19) United States
(12) Patent Application Publication
(10) Pub. No.: US 2025/0150543 A1
(43) Pub. Date: May 8, 2025

(54) LIGHT GUIDE, ILLUMINATION DEVICE, AND CONTACT IMAGE SENSOR

(71) Applicant: Nippon Sheet Glass Company , Limited, Tokyo (JP)

(72) Inventors: Kazutaka ABOSHI, Yokohama-shi (JP); Shigeo KITTAKA, Nishinomiya-shi (JP); Takeshi ISHIMARU, Yokohama-shi (JP); Kazuya HOSHINA, Yokohama-shi (JP)

(21) Appl. No.: 19/016,207

(22) Filed: Jan. 10, 2025

Related U.S. Application Data
(63) Continuation of application No. PCT/JP2022/027602, filed on Jul. 13, 2022.

(51) Int. Cl. H04N 1/028; F21V 8/00; H04N 1/10

(52) U.S. Cl. CPC H04N 1/02895; G02B 6/0035; H04N 1/02805; H04N 1/1061

(57) ABSTRACT

A light guide propagates, in a longitudinal direction, light incident on an end surface while reflecting the light on an inner surface and emits the light from a light emission surface. The light guide includes a light reflecting surface substantially facing the light emission surface, and multiple diffusion structures provided on the light reflecting surface to diffuse and reflect light. When the length of a diffusion structure in a direction perpendicular to a longitudinal direction is defined as Wr and the length of the light reflecting surface in a direction perpendicular to a longitudinal direction is defined as Wp, Wr<Wp holds.

### CROSS-REFERENCE TO RELATED APPLICATION

This application is a continuation application of International Application No. PCT/JP2022/027602 filed on Jul. 13, 2022, the entire contents of which are incorporated herein by reference.

### BACKGROUND

### 1. Technical Field

The present disclosure relates to a light guide that guides light from a light source and emits the light, and an illumination device and a contact image sensor using the light guide.

### 2. Description of the Related Art

In a device such as a facsimile, copier, and hand scanner, an image reader such as an image sensor is used as a device for reading an original document. A contact image sensor (CIS) is used as a type of image reader, which has a short optical path length and is easy to incorporate into a device. Such a contact image sensor reads part of an original document to be read, which is illuminated by an illumination device such that the illuminance becomes higher than illuminance at which reading is possible. The illumination range is strip-shaped, which is long in the main scanning direction (longitudinal direction) and narrow in the sub-scanning direction that is perpendicular to the main scanning direction. For this reason, the illumination device used for a contact image sensor is sometimes referred to as a “linear illumination device”.

Patent Literature 1 describes an invention relating to a light guide used in an illumination device. The light guide described in Patent Literature 1 is a rod-shaped body that propagates light therein in a longitudinal direction while subjecting the light to multiple reflection. The light guide includes a light incidence surface, at an end thereof, on which light from a light source such as an LED is incident, a light emission surface from which the light is emitted linearly, and a light reflecting surface that substantially faces the light emission surface. In the light guide described in Patent Literature 1, by forming an uneven shape or a concave portion with a substantially circular cross section on part of the light reflecting surface, inconsistent irradiation is suppressed.

### PRIOR ART REFERENCE

### Patent Literature

Patent Literature 1: Japanese Unexamined Patent Application Publication No. 10-133026

The illumination device including the light guide described in Patent Literature 1 suggests suppressing inconsistency on the illumination surface without providing a conventional light reflecting coating film on the light reflecting surface. However, there is no mention, for example, of reduction in radiant flux or irradiance in the case where part of the original document placed on the document table (also referred to as a contact glass or platen glass) comes off, i.e., part of the original document becomes away from the document table surface with which it is supposed to be in close contact. In actual work, since it is often necessary to read an image of an original document that is partially not in contact with the contact table, it is strongly desired to equalize the amount of radiation, such as radiant flux and irradiance, regardless of whether it is a surface in contact with the contact glass or a surface positioned away from the contact glass.

### SUMMARY

The present disclosure has been made in view of such a situation, and a general purpose thereof is to equalize the amount of radiation, such as radiant flux and irradiance, on a transparent document table.

In response to the above issue, a light guide according to one embodiment of the present disclosure is a light guide that propagates, in a longitudinal direction, light incident on an end surface while reflecting the light on an inner surface and emits the light from a light emission surface. The light guide includes: a light reflecting surface substantially facing the light emission surface; and multiple diffusion structures provided on the light reflecting surface to diffuse and reflect light. When the length of a diffusion structure in a direction perpendicular to a longitudinal direction is defined as Wr and the length of the light reflecting surface in a direction perpendicular to a longitudinal direction is defined as Wp, Wr<Wp holds.

Another embodiment of the present disclosure relates to an illumination device. The illumination device includes the abovementioned light guide, and a light source disposed on the end surface or in the vicinity of the end surface so that light enters the light guide from the end surface.

Yet another embodiment of the present disclosure relates to a contact image sensor. The contact image sensor includes: a document table; the abovementioned illumination device used to illustrate an original document placed on the document table; a lens array that condenses reflected light from part of the original document illustrated by the illumination device; and a light receiving element array that receives light condensed by the lens array.

Optional combinations of the aforementioned constituting elements, and methods, devices, and the like among which expressions in the present disclosure are changed are also effective as embodiments of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic perspective view of a contact image sensor according to an embodiment of the present disclosure;

FIG. 2 is a schematic sectional view perpendicular to a longitudinal direction of the contact image sensor according to the embodiment of the present disclosure;

FIG. 3 is a schematic perspective view of an example of an erecting equal-magnification lens array;

FIG. 4 is a schematic perspective view of an example of an illumination device used for the contact image sensor;

FIGS. 5A and 5B are schematic diagrams of an LED package with multiple LED chips mounted therein;

FIGS. 6A-6C constitute a schematic three-view drawing that shows an example of a light guide with multiple diffusion structures constituted by divided cylindrical sides provided on a light reflecting surface;

FIG. 7 is an enlarged schematic plan view of the light reflecting surface provided with diffusion structures constituted by divided cylindrical sides;

FIG. 8 shows a diffusion structure constituted by a divided cylindrical side;

FIG. 9 is an enlarged schematic plan view of the light reflecting surface provided with diffusion structures constituted by spherical concave portions;

FIG. 10 shows a diffusion structure constituted by a spherical concave portion;

FIG. 11 is a graph that qualitatively shows the dependence of irradiance at the document table in a z-direction;

FIG. 12 is a sectional view of a light guide according to another embodiment;

FIGS. 13A-13C constitute a schematic three-view drawing of a light guide according to a first example;

FIG. 14 is a schematic enlarged view of part of a group of groove-shaped diffusion structures;

FIG. 15 shows an illumination device according to a second example;

FIG. 16 is a schematic sectional view perpendicular to a longitudinal direction of a contact image sensor according to a third example;

FIG. 17 shows relationships between the y-dependence and z-dependence of irradiance at a reading position and in the vicinity thereof;

FIGS. 18A-18C constitute a schematic three-view drawing of a light guide according to a fourth example;

FIG. 19 shows relationships between the y-dependence and z-dependence of irradiance at the reading position and in the vicinity thereof;

FIGS. 20A-20C constitute a schematic three-view drawing of a light guide according to a first comparative example; and

FIG. 21 shows relationships between the y-dependence and z-dependence of irradiance at the reading position and in the vicinity thereof.

### DETAILED DESCRIPTION

The invention will now be described by reference to the preferred embodiments. This does not intend to limit the scope of the present invention, but to exemplify the invention.

In the following, embodiments of the present disclosure will be described. Like reference characters denote like or corresponding constituting elements, members, and processes in each drawing, and repetitive description will be omitted as appropriate. The embodiments are intended to be illustrative only and not to limit the invention, so that it should be understood that not all of the features or combinations thereof described in the embodiments are necessarily essential to the invention.

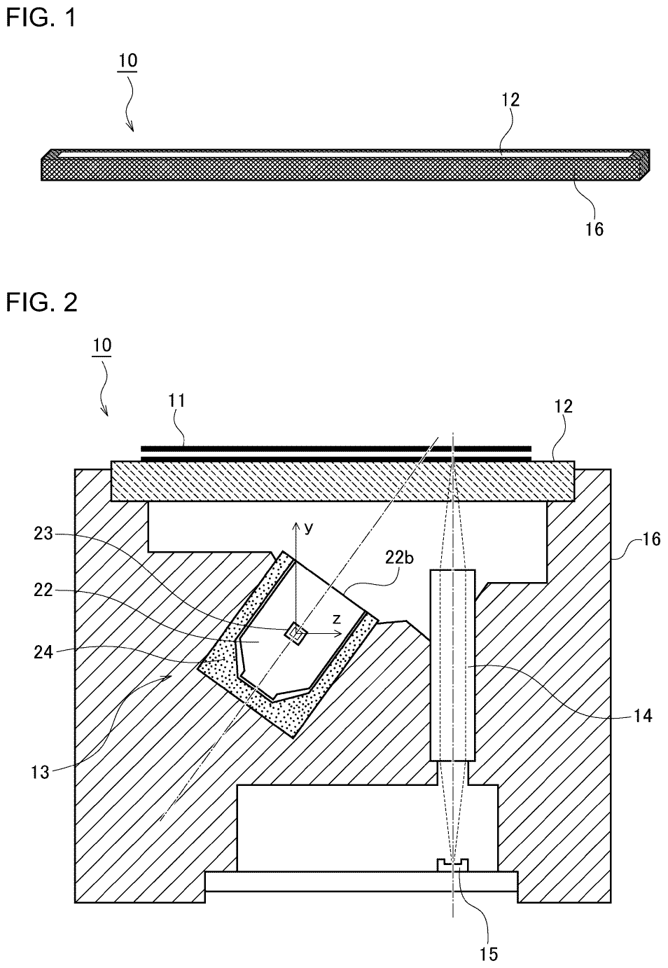

FIG. 1 is a schematic perspective view of a contact image sensor 10 according to an embodiment of the present disclosure. As shown in FIG. 1, the contact image sensor 10 may have a length in a longitudinal direction corresponding to the width or length of the original document or work to be read. For example, when the original document to be read is A4 size, the contact image sensor 10 may have a length corresponding to the width of A4 paper.

FIG. 2 is a schematic sectional view perpendicular to a longitudinal direction of the contact image sensor 10 according to the embodiment of the present disclosure. As shown in FIG. 2, the contact image sensor 10 includes: a document table 12 that is transparent and of parallel plate shape, on which an original document 11, of which an image is to be read, is placed; an illumination device 13 that illuminates part of the original document 11 placed on the document table 12; an erecting equal-magnification lens array 14 that condenses an image of part of the original document 11 illuminated by the illumination device 13, as an erect equal-magnification image; and a light receiving element array 15 that reads the image condensed by the erecting equal-magnification lens array 14. Further, the contact image sensor 10 shown in FIG. 1 includes a housing 16 that integrates these components in an appropriate arrangement.

The document table 12 is configured as a transparent parallel plate. Since the document table 12 is required to be highly transparent, it may be made of glass or transparent resin with high light transmittance, such as cycloolefin, acrylic, or polycarbonate. If significantly high mechanical strength and high light transmittance is required, tempered glass may be used. When the document table 12 is made of glass, it may be referred to as the platen glass, contact glass, or document glass. As shown in FIG. 1, the document table 12 may be long in one direction and may be rectangular in its plan view, with long sides in a certain direction.

The erecting equal-magnification lens array 14 is constituted by a large number of single lenses having an object-image relationship of an erecting equal-magnification system and arranged such that the optical axes of the lenses are parallel to each other at least in the longitudinal direction (the main scanning direction). Although a lens array of an erecting equal-magnification system is employed here, a lens array of a non-erecting imaging system or of a non-equal magnification imaging system may also be employed. In terms of the requests for downsizing of the contact image sensor 10 and robustness regarding resistance to positional displacement of each part, employing an erecting equal-magnification lens array is preferable.

As the lens array, a SELFOC lens array (SELFOC is a registered trademark) manufactured by Nippon Sheet Glass Co., Ltd., a plastic lens array manufactured by Mitsubishi Chemical Corporation, and Linear Micro Lens Array (Doublet Lens) from Pixon Technologies Corp. can be used. Each of the single lenses constituting the former two is a graded-index rod lens having a refractive index distribution in which the refractive index decreases from the center to the periphery, inside a transparent cylindrical dielectric, which can provide a function to refract light even if the boundary surface with air is not a curved surface or the like.

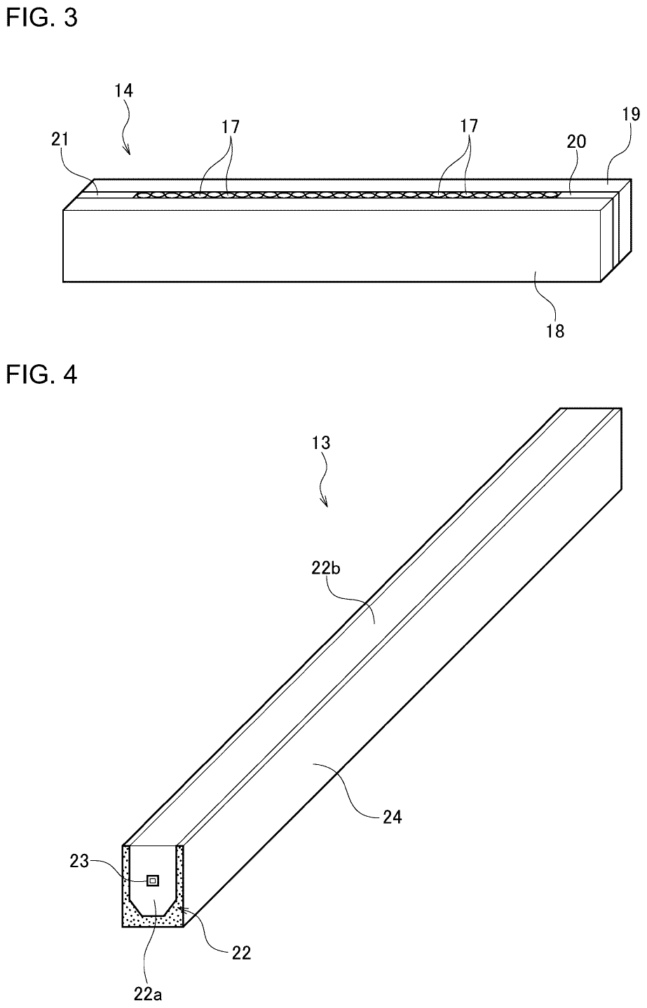

FIG. 3 is a schematic perspective view of an example of the erecting equal-magnification lens array 14. The erecting equal-magnification lens array 14 shown in FIG. 3 is constituted by multiple graded-index rod lenses 17 arranged in one or more rows in the main scanning direction such that the central axes thereof are substantially parallel to each other (the lens array shown in FIG. 3 is arranged in one row). As shown in FIG. 3, the erecting equal-magnification lens array 14 is held between two plate-shaped substrates 18 and 19 and is integrated together with spacers (plates) 20 and 21 arranged at both ends.

In such an erecting equal-magnification lens array 14, an end surface corresponding to the light emission/incidence surface need not be a curved surface or the like, as described previously, providing extremely efficient workability. In addition, the lens diameter can be reduced, the resolution and contrast are high, and an erect equal-magnification image can be easily obtained.

The light receiving element array 15 is constituted by light receiving elements, such as photodiodes (PDs) and avalanche photodiodes (APDs), arranged long at least in the main scanning direction. The light receiving element array 15 receives light reflected from an image of part of the original document 11 on the document table 12 and then condensed by the erecting equal-magnification lens array. The light received by the light receiving element array 15 is converted into an electrical signal based on the light intensity and is transmitted to a device such as a storage device or an image processing engine.

The light receiving element array 15 may be, for example, arranged in three rows in the sub-scanning direction, and the light receiving elements in each row may be provided with a color filter corresponding to R (red), G (green), or B (blue) on the light receiving surface. Also, the light of an image of the original document emitted from the erecting equal-magnification lens array 14 may be dispersed by a diffraction grating or a spectroscopic prism, and each dispersed light may be received by one of the three rows of the light receiving element array 15 arranged in the sub-scanning direction, so as to obtain a color image of the original document.

FIG. 4 is a schematic perspective view of an example of the illumination device 13 used for the contact image sensor 10. The illumination device 13 includes a light guide 22 of rod shape that is long in the main scanning direction, a light source 23 disposed such that the light therefrom is incident on at least one end surface 22a of the light guide 22, and a light guide cover 24 that houses the light guide 22.

Since FIG. 2 is a sectional view perpendicular to the main scanning direction (longitudinal direction) of the contact image sensor 10, the end surface 22a of the light guide 22 or the light source 23 disposed in the vicinity thereof cannot be shown in FIG. 2. However, in FIG. 2, a light source axis passing through the center of the light source 23 is assumed in a direction perpendicular to the drawing surface, and the light source 23 is illustrated at the position corresponding to the axis line.

In the contact image sensor 10 shown in FIG. 2, with the position of the light source 23 set as the origin, a Cartesian coordinate system is set with the x-axis (light source axis) passing through the origin and perpendicular to the drawing surface, the z-axis passing through the origin, perpendicular to the x-axis, and parallel to the surface of the document table, and the y-axis passing through the origin and perpendicular to the x-axis and z-axis. From the perspective of the scanning property of the contact image sensor 10, the longitudinal direction of each part, which is perpendicular to the drawing surface, i.e., the x-direction, is referred to as the main scanning direction, and a direction perpendicular to the main scanning direction, i.e., the z-direction, is referred to as the sub-scanning direction.

The function of the illumination device 13 will now be described. For example, in FIG. 4, light emitted from the light source 23 disposed on or near the end surface 22a of the light guide 22 enters the light guide 22 from the end surface 22a. The light that has entered the light guide 22 propagates within the light guide 22 in the longitudinal direction. The light guide 22 includes a light emission surface 22b from which light is linearly emitted in the longitudinal direction, and side surfaces other than the light emission surface 22b. The light emission surface 22b and side surfaces are long in one direction. One of the side surfaces of the light guide 22 can be a light reflecting surface that directs the traveling of part of the light to the light emission surface 22b. The light reflecting surface may include the surface facing the light emission surface 22b.

The light source 23 may be an LED, for example. The LED may emit white light. The light source 23 may be multiple LED chips that emit light with wavelengths corresponding to red, green, and blue, respectively, housed in one package. In this case, by sequentially allowing the LED chips of the three colors to emit light and by sequentially detecting the light intensity at the times of the emissions, a color image of the original document can be obtained even with a single row of the light receiving element array 15, through image processing or the like in the subsequent process. Also, for example, LED chips that emit light with wavelengths corresponding to red and blue may be used, and also an LED obtained by impregnating those LED chips with transparent resin containing a fluorescent agent and housing them in one package may be used. Further, by allowing fluorescence with a wavelength corresponding to green to be emitted from a fluorescent agent excited by part of light with a wavelength corresponding to blue, it may be used as an LED that presents a white color from the light emission surface of the package. Meanwhile, the illumination device 13 can be configured by arranging LED chips that emit light with wavelengths corresponding to red, green, and blue, on the end surface 22a of the light guide 22. In that case, by sequentially allowing the LED chips of the three colors to emit light, by detecting the color and the light intensity in the light receiving element array 15 at the times of the emissions, and by performing processing such as mixing by means of the function of an image processing device or the like, a color image of the original document can be obtained. If the dependence of the irradiance of the light emitted from the illumination device 13 on the position of the LED on the end surface is known in advance, properties such as irradiance and radiant flux can be reflected in a specific position on the end surface 22a of the light guide 22 where relatively large radiation intensity can be obtained, and the irradiance of each color on the original document and in the vicinity thereof can be equalized.

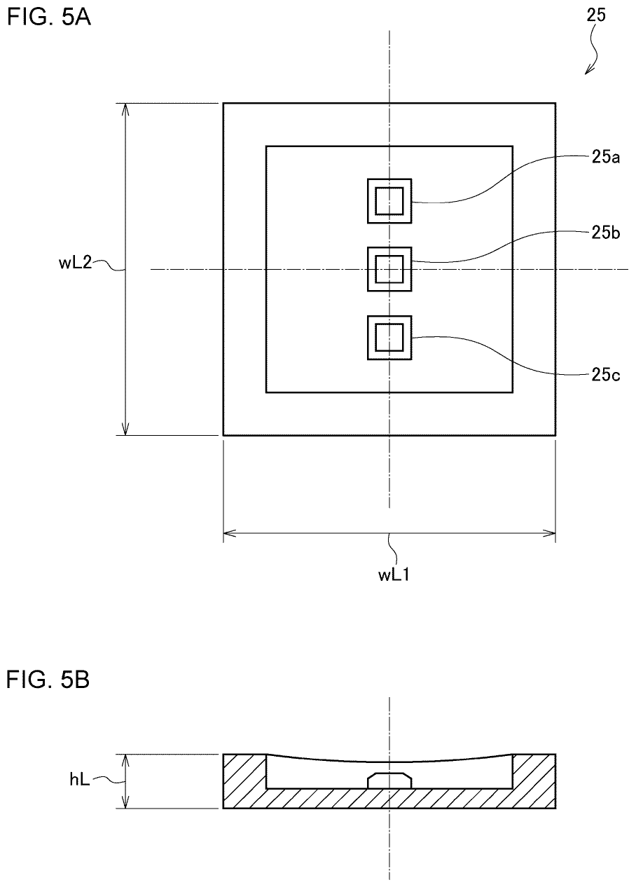

FIGS. 5A and 5B are schematic diagrams of an LED package 25 in which LED chips 25a, 25b, and 25c, which respectively emit light in single colors of R (red), G (green), and B (blue), are mounted in one package. FIG. 5A is a plan view of the LED package 25, and FIG. 5B is a sectional view of the LED package 25.

When viewed in plan view, the LED package 25 may have a horizontal length wL1 of 0.7 mm to 3 mm, for example, a vertical length wL2 of 0.7 mm to 3 mm, for example, and wL1 may be equal to wL2. Also, the LED package 25 may have a height hL of 0.3 mm to 5 mm, for example.

The light guide 22 may be constituted by a transparent dielectric for effective propagation of light. At least in the light guide 22, absorption may preferably be smaller in the wavelength range of light to be used, and the light guide 22 may preferably be made of a material with high internal transmittance. An example of such a material may be glass. Also, an example of the material constituting the light guide 22 may be transparent resin (plastic), from the viewpoint of its formability. Examples of the resin include, but are not limited to, polymethyl methacrylate (acrylic resin), polycarbonate, polystyrene, AS resin, epoxy resin, silicone resin, and cycloolefin resin.

The light guide 22 may have a substantially rectangular shape in a cross section perpendicular to the x-direction (longitudinal direction) (hereinafter, simply referred to as a “cross section of the light guide”). Besides the substantially rectangular shape, the shape of the cross section of the light guide 22 may be an arbitrary figure constituted by straight lines and curves. In particular, when a curve includes part of an ellipse, it may be expected that the function of confining light within the light guide due to the effect of having a focal point is served and also that the efficiency of extracting light from the light guide 22 is improved.

When the cross-sectional shape of the light guide 22 is substantially rectangular, one or some corners may be constituted by C or R chamfers. The irradiance or radiation intensity of light tends to decrease in a portion of the light guide 22 that is relatively far from the light source 23. In order to compensate for it, the cross-sectional shape of the light guide 22 may vary depending on the position in the longitudinal direction.

The light guide 22 includes the light emission surface 22b extending in the longitudinal direction. The light emission surface 22b has a function as a surface that extracts, from the light guide 22, light used for illumination. The light emission surface 22b is disposed to effectively illuminate the image reading position of the original document 11 on the document table 12. The light emission surface 22b may be oriented in the direction toward the image reading position.

The light emission surface 22b may be a flat surface or a surface including a curved surface. When the light emission surface 22b includes a curved surface, by providing it with the function of focusing light, the radiation intensity or irradiance of light at a specific location can be increased or controlled conversely. The surface roughness of the light emission surface 22b is not specified, and the surface may be a so-called mirror surface or may include unevenness. In the case of the mirror surface or when the unevenness on the surface is very small, the directivity of light rays extracted from the light emission surface 22b can be easily controlled. When the unevenness on the surface is large enough to cause scattering or diffusion of light, such scattering, diffusion, and other effects including diffuse reflection can equalize the illumination light.

The light guide 22 also includes side surfaces extending in the longitudinal direction other than the light emission surface 22b. Each side surface may function as a reflecting surface for propagating light in the longitudinal direction of the light guide 22 inside the light guide 22. Inside the light guide 22, light propagates in the longitudinal direction of the light guide 22 by repeating reflection on part of a side surface. When the angle made when the light propagating within the light guide 22 reaches a side surface is sufficiently large, the light propagates while being totally reflected or being reflected in a manner close to total reflection. When the light reaches a side surface of the light guide 22 under conditions that do not lead to total reflection, part of the light may be emitted from the side surface. Each side surface of the light guide 22 may be a flat surface or a surface including a curved surface. When the light emission surface 22b includes a curved surface, it can be provided with the function of focusing light. The surface roughness of each side surface of the light guide 22 is not specified. When the unevenness on the surface is small, the directivity of the light rays to be extracted from the light emission surface 22b can be easily controlled. When the unevenness on the surface is large enough to cause scattering or diffusion of light, such scattering or diffusion effect can equalize the irradiance or radiation intensity of the light within the light guide 22.

At least part of a side surface of the light guide 22 may have a function such as directing part of light reflected or the like to the light emission surface 22b. A portion having such a function will be referred to as a “light reflecting part”. When the cross-sectional shape of the light guide 22 is rectangular, the light guide 22 includes multiple side surfaces defined by the sides. On the other hand, the side surfaces may not sometimes be defined by clear sides, such as when the cross-sectional shape of the light guide 22 is substantially circular or elliptic. When the cross-sectional shape of the light guide 22 is rectangular, at least one surface of the light guide 22 may be a surface having the function of the light reflecting part. A side surface that partially has the function of the light reflecting part will be referred to as a “light reflecting surface”. The light reflecting surface may be a surface facing the light emission surface or part of the surface.

The light reflecting surface may include a configuration for directing part of light that has reached the light reflecting surface or a portion thereof, to the light emission surface 22b. A configuration for performing or improving the function of the light reflecting surface is not specified. For example, the light reflecting surface may partially include a colored portion, such as a silver or white portion, to improve the light reflection efficiency. Such a silver or white portion may be provided by painting or printing. Such coloring with high light reflectivity increases the radiation of light that reaches part of the light reflecting surface and then reflects toward the light emission surface. Also, the surface of a colored portion, such as a silver or white portion, provided in part of a surface of the light guide by painting or printing may be or may not be a mirror surface. When the surface of such a colored portion is not a mirror surface, it promotes diffuse reflection of light, directs the light to the light emission surface, and also helps to equalize the amount of radiation, such as irradiance and radiation intensity, of light.

Also, a colored portion, such as a silver or white portion, provided in part of the light reflecting surface by printing or painting may have a pattern that varies along the longitudinal direction of the light guide 22. Inside the light guide 22, the farther away from the light source 23, the smaller the amount of radiation, such as irradiance and radiation intensity; accordingly, the amount of radiation of light that is reflected on the light reflecting surface and then directed toward the light emission surface 22b also decreases. Therefore, a pattern may be made such that, in a location farther away from the light source 23, the area of a portion for improving the light reflective property, such as a white or silver portion, is larger, and, in a portion closer to the light source 23, the area of the reflective portion is smaller.

When the light reflecting surface does not include a colored portion, such as a silver or white portion, provided by printing or painting, the amount of radiation of light that reaches the light reflecting surface and is then directed to the light emission surface 22b may be smaller. Such a case is not preferable because the efficiency of extracting light from the light emission surface 22b decreases. The light reflecting surface may include a concave or convex structure in order to partially improve or control the diffuse reflectivity and scattering properties. For example, it is assumed here that the light reflecting surface has a concave portion that includes part of a side surface of a cylinder. When light reaches the light reflecting surface at a certain incidence angle, the diffuse reflectivity of the light is higher when the light is reflected by a concave surface than when reflected by a flat surface. The diffuse reflectivity means a state in which, when multiple light rays reach a certain surface, the light rays are reflected at multiple reflection angles rather than at a certain reflection angle, thereby being reflected while spreading (diffusing) as a whole. When the light reflecting surface does not include such a structure or a colored portion, it has a strong effect of promoting propagation of light inside the light guide 22, so that the amount of radiation of light directed to the light emission surface 22b cannot be increased, and the light extraction efficiency becomes relatively poor. A structure that diffuses and reflects part of light on the light reflecting surface will be referred to as a “diffusion structure”.

The form of a diffusion structure on the light reflecting surface is not specified as long as it is a structure that diffuses and reflects part of light that has reached the light reflecting surface. For example, the invention disclosed in Published Japanese Translation of PCT Application No. 2006-120932 or Japanese Unexamined Patent Application Publication No. 2003-197016 discloses a light guide that includes spherical concave portions, triangular grooves (V-shaped grooves), and divided cylindrical grooves (U-shaped grooves) on a surface facing the light emission surface, which is referred to as the light scattering surface. The form of a diffusion structure in the present embodiment can be any of these or an appropriate combination thereof. According to the aforementioned patent documents, those structures similar to the diffusion structures are formed for the purpose of reducing inconsistency in the amount of radiation, such as inconsistency in color or luminance.

Diffusion structures with these conditions may be provided on the entire light reflecting surface, or the light reflecting surface may partially include a light reflecting surface provided with diffusion structures with these conditions. Also, diffusion structures with these conditions may be provided in combination as appropriate. The light guide 22 in the present embodiment may include diffusion structures partially on the light reflecting surface.

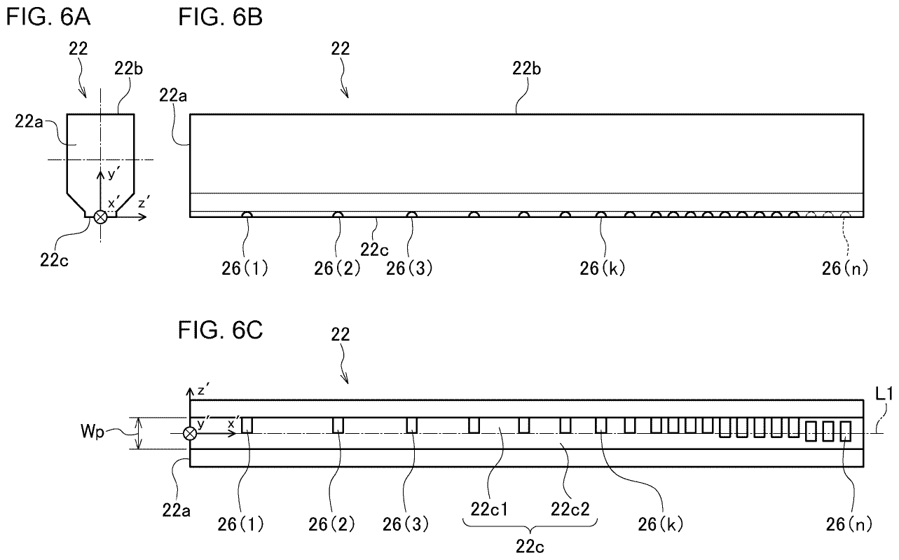

FIGS. 6A-6C constitute a schematic three-view drawing that shows an example of the light guide of substantially rectangular prism shape with multiple diffusion structures constituted by divided cylindrical sides (U-shaped grooves) provided on the light reflecting surface. FIG. 6A shows the light guide 22 viewed from the end surface 22a side, FIG. 6B shows some of the side surfaces of the light guide 22, and FIG. 6C shows the light guide 22 viewed from the light reflecting surface side. In FIGS. 6A-6C, an x′y′ z′ Cartesian coordinate system is shown. The light guide 22 shown in FIGS. 6A-6C includes the light emission surface 22b perpendicular to the end surface 22a, and a light reflecting surface 22c that faces the light emission surface 22b. Although the light emission surface 22b and the light reflecting surface 22c are parallel in this light guide 22, the light emission surface 22b and the light reflecting surface 22c may have a relationship in which the distance between them tapers off along the longitudinal direction, for example.

In the light guide 22 shown in FIGS. 6A-6C, a direction parallel to the end surface 22a is set as the y′-direction, a longitudinal direction of the light guide 22 (a direction perpendicular to the drawing surface in FIG. 6A) perpendicular to the y′-direction is set as the x′-direction, and a direction perpendicular to the x′-direction and the y′-direction and parallel to the light reflecting surface 22c is set as the z′-direction. The intersection of the side connecting the end surface 22a and the light reflecting surface 22c and a bisector that bisects the light reflecting surface 22c in the z′-direction and is parallel to the x′-direction is set as the origin.

FIG. 6C shows a dashed dotted line L1 that divides the light reflecting surface 22c into two parts and is parallel to the x′-direction (although there is no such line in the actual light guide 22, it is shown for illustration). In the light reflecting surface 22c shown in FIG. 6C, the upper side above the dashed dotted line L1 is a first reflecting surface 22c1, and the lower side therebelow is a second reflecting surface 22c2.

As shown in FIGS. 6A-6C, on the light reflecting surface 22c of the light guide 22, multiple diffusion structures 26(k) are formed along the longitudinal direction of the light guide 22 (k=1, 2, . . . n). In order from closest to the origin in the x′y′z′ Cartesian coordinate system, the diffusion structures are referred to as diffusion structures 26(1), 26(2), . . . 26(n). In the following, when diffusion structures are collectively referred to, they will be simply referred to as diffusion structures 26.

In the light guide 22 shown in FIGS. 6A-6C, a length Wr(k) parallel to the z′-direction, or perpendicular to the main scanning direction, of each diffusion structure 26(k) is expressed as Wr(k)<Wp, where Wp is the width, or the length in the z′-direction, of the light reflecting surface 22c. The lengths Wr(k) of one or some of the diffusion structures 26(k) are shorter than ½×Wp, and the lengths Wr(k) of another one or some other of the diffusion structures 26(k) are substantially equal to ½×Wp, so that Wr(k)≤½×Wp holds. Also, the lengths Wr(k) of another one or some other of the diffusion structures 26(k) are longer than ½×Wp. Also, the ends in the z′-direction of one or some of the diffusion structures 26(k) do not reach the end in the z′-direction, or the side, of the light reflecting surface 22c.

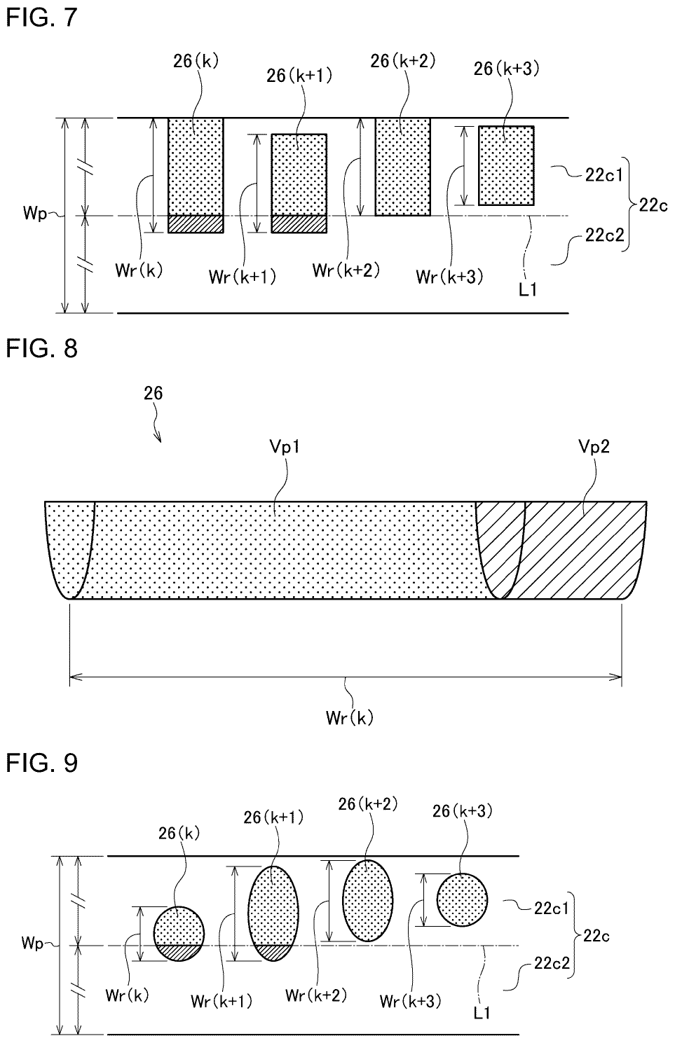

FIG. 7 is an enlarged schematic plan view of the light reflecting surface 22C provided with diffusion structures constituted by divided cylindrical sides. FIG. 7 illustrates four diffusion structures 26(k) to 26(k+3). Some diffusion structures 26(k) and 26(k+1) are provided across the first reflecting surface 22c1 and the second reflecting surface 22c2. Also, some diffusion structures 26(k+2) and 26(k+3) are provided only on the first reflecting surface 22c1. In the plan view of the diffusion structures 26 provided on the light reflecting surface as shown in FIG. 7, a center line that bisects a diffusion structure 26 in the x′-direction may be assumed, and the length along the center line of the diffusion structure 26 may be used as the length of the diffusion structure 26, or the maximum length in the z′-direction of the diffusion structure 26 may be used as the length of the diffusion structure 26. Also, the width of the light reflecting surface 22c along an extended line of the center line of a diffusion structure 26 may be used as Wp, and, when the light reflecting surface is substantially rectangular in plan view, Wp may be made equal to the length of a side in the z′-direction or the width of a center part of the light reflecting surface. The length and Wp of a diffusion structure 26 can be measured with a measuring microscope, a projector with a measuring device, a caliper, a micrometer, or the like.

The volume of part of a diffusion structure 26 located in the first reflecting surface 22c1 is defined as Vp1, and the volume of part of the diffusion structure 26 located in the second reflecting surface 22c2 is defined as Vp2. FIG. 8 shows a state where a diffusion structure 26 provided across the first reflecting surface 22c1 and the second reflecting surface 22c2 is divided into a region of the volume Vp1 located in the first reflecting surface 22c1 and a region of the volume Vp2 located in the second reflecting surface 22c2.

In the present embodiment, in some of the diffusion structures 26 shown in FIGS. 6C and 7, Vp2<Vp1 holds. Further, diffusion structures 26 in which Vp2<0.5×Vp1 holds are also included, and diffusion structures 26 in which Vp2=0 holds are further included.

The relationship between Vp1 and Vp2 in each diffusion structure 26 is Vp2≤Vp1, may preferably be Vp2≤0.5×Vp1, more preferably be Vp2≤0.25×Vp1, and particularly preferably be Vp2≤0.1×Vp1. Further, Vp2=0 may also hold.

Although a diffusion structure 26 of concave shape that includes a side surface of a cylinder has been described, it is not limited to a strict cylinder, and a diffusion structure 26 may include a side surface of a substantial cylinder, such as that with an elliptical or oval cross section. As long as light reaching the diffusion structure 26 is reflected (diffused) in various directions, the shape thereof is not limited. Each diffusion structure 26 may have a depth of 0.05 mm to 2 mm, and a width of 0.2 mm to 10 mm in the x′-direction, which is parallel to the light reflecting surface 22c. Also, each diffusion structure 26 may have a form in which, in the plan view of the light reflecting surface on which the diffusion structure 26 is disposed, the width or depth of the diffusion structure 26 tapers off in the z′-direction.

FIG. 9 is an enlarged schematic plan view of the light reflecting surface 22c provided with diffusion structures constituted by spherical concave portions. In FIG. 9, as in FIG. 7, the dashed dotted line L1 that divides the light reflecting surface 22c into two parts is shown. FIG. 9 illustrates four diffusion structures 26(k) to 26(k+3). Some diffusion structures 26(k) and 26(k+1) are provided across the first reflecting surface 22c1 and the second reflecting surface 22c2. Also, some diffusion structures 26(k+2) and 26(k+3) are provided only on the first reflecting surface 22c1.

For the diffusion structures 26 shown in FIG. 9, Wr(k)<Wp holds. For one or some of the diffusion structures 26, Wr(k)≤½×Wp holds, and, for another one or some other of the diffusion structures 26, ½×Wp<Wr(k)<⅗×Wp holds. In the plan view of the diffusion structures 26 provided on the light reflecting surface as shown in FIG. 9, a center line that bisects a diffusion structure 26 in the x′-direction may be assumed, and the length along the center line of the diffusion structure 26 may be used as the length of the diffusion structure 26, or the maximum length in the z′-direction of the diffusion structure 26 may be used as the length of the diffusion structure 26. Also, the width of the light reflecting surface 22c along an extended line of the center line of a diffusion structure 26 may be used as Wp, and, when the light reflecting surface is substantially rectangular in plan view, Wp may be made equal to the length of a side in the z′-direction or the width of a center part of the light reflecting surface. The length and Wp of a diffusion structure 26 can be measured with a measuring microscope, a projector with a measuring device, a caliper, a micrometer, or the like.

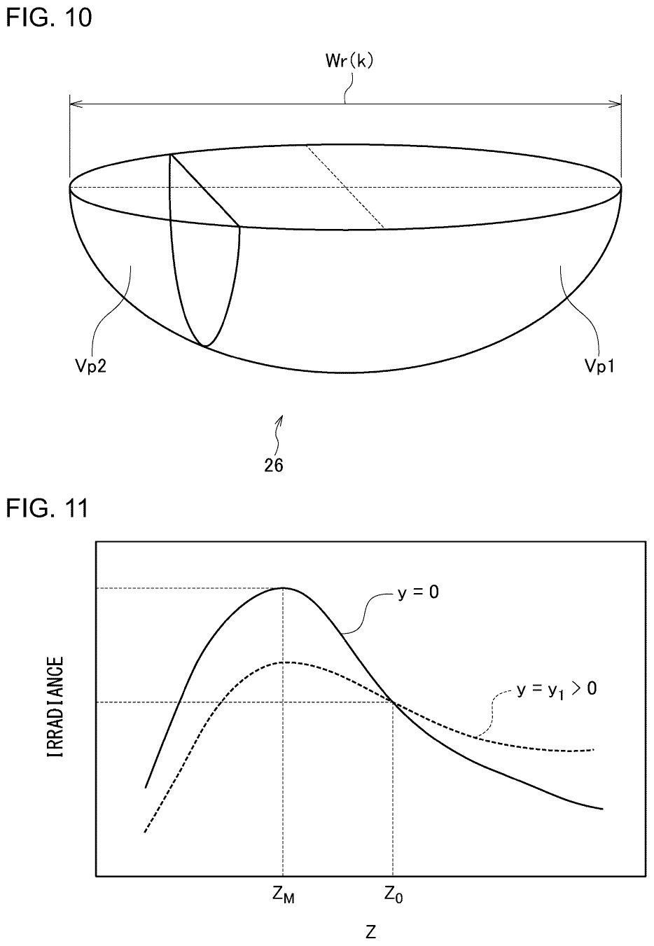

FIG. 10 shows a state where a diffusion structure 26 provided across the first reflecting surface 22c1 and the second reflecting surface 22c2 is divided into a region of the volume Vp1 located in the first reflecting surface 22c1 and a region of the volume Vp2 located in the second reflecting surface 22c2. In the present embodiment, Vp2<Vp1 holds in some of the diffusion structures 26. Further, Vp2<0.5×Vp1 holds, and Vp2=0 holds in some other.

The diffusion structures 26 constituted by spherical concave portions may be provided only on the first reflecting surface 22c1. In plan view, each of the diffusion structures 26 constituted by spherical concave portions may be circular or may be elliptical or oval. A curved surface portion of the spherical concave portion may be part of a spherical surface or may be part of an aspherical shape, such as part of a spheroid.

The diffusion structures 26 constituted by U-shaped grooves as described previously or by spherical concave portions are not limited to those described above. Also, both the diffusion structures 26 of groove shape and the diffusion structures 26 of spherical concave shape may be included in the light reflecting surface 22c. When the illumination device 13 is configured with the light guide 22 in which diffusion structures 26 that satisfy the above conditions are included in the light reflecting surface 22c, the line width of linear illumination light emitted from the illumination device 13 becomes smaller, and the amount of radiation such as the irradiance in the center becomes larger. As described previously, when there is no white portion or the like provided by printing or painting, which is for reflection or diffuse reflection of light, the light reflecting surface without diffuse structures and side surfaces including the light reflecting surface have a strong effect of propagating light rays that have reached the surfaces, in the longitudinal direction of the light guide. Therefore, the diffusion structures 26 are provided to increase the amount of radiation of light directed to the light emission surface 22b. In addition, by limiting the lengths of the diffusion structures 26 in a width direction of the light reflecting surface 22c (making the lengths smaller than the width of the light reflecting surface 22c), the concentration of the distribution of irradiance directed to the light emission surface 22b is increased, and the line width of the illumination light emitted linearly becomes smaller. For example, it can be said that, in the light reflecting surface 22c, the first reflecting surface 22c1 functions to increase the amount of radiation of light directed to the light emission surface 22b, and the second reflecting surface 22c2 functions to increase the amount of radiation of light propagating in the longitudinal direction of the light guide 22. The line width of linear light emitted from the illumination device 13 becoming smaller has the advantage of increasing the irradiance provided to the original document 11 on the document table 12.

For the contact image sensor 10, there is a request to make the irradiance received by a reading target part in the original document 11 constant when the reading target part in the original document 11 on the document table 12 is shifted in the y-direction (or gets away from the document table 12, which may be sometimes expressed as when the original document gets into a “floating” state).

FIG. 11 is a graph that qualitatively shows the dependence of irradiance on the document table 12 in the z-direction in the contact image sensor 10 for each of the conditions of y=0 (the document table surface) and y=y1 (a position shifted by y1 in the y-direction). From this, it can be seen that, at z=z₀, there is a singularity where the irradiance does not change with a shift in the y-direction, or where the difference in irradiance is minimal. For the contact image sensor 10, the illumination device 13 is designed, while rotating it about the axis in the x-direction, considering a length pertaining to a predetermined y, and z₀ as the singularity at the time.

In the present embodiment, by linear illumination with a small line width emitted from the illumination device 13, light having an irradiance distribution with small dispersion, in which concentration of irradiance in a center part is high, reaches the vicinity of the original document 11. Accordingly, it is suggested that, in the relationship representing the dependence of the irradiance on the document table 12 in the z-direction, the difference between the value of z (z_{M}) corresponding to a part with high irradiance and the value of z₀ corresponding to the singularity becomes small, and the amount of radiation such as irradiance at the singularity becomes large.

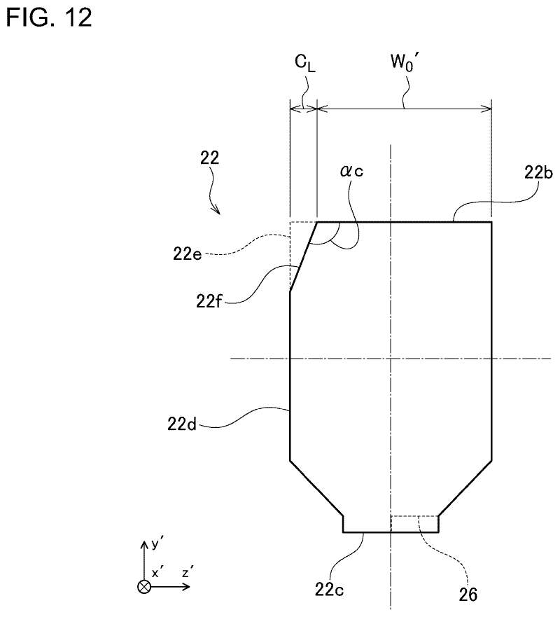

FIG. 12 is a sectional view of the light guide 22 according to another embodiment. As shown in FIG. 12, the light guide 22 may be chamfered at part of a corner portion 22e on a side surface 22d, which substantially faces a diffusion structure 26 on the cross section. Accordingly, a new side surface 22f that substantially faces a diffusion structure 26 on the cross section of the light guide 22 is created. With the new side surface 22f substantially facing the diffusion structures 26 provided, part of light diffused and reflected by the diffusion structures 26 reaches the new side surface 22f and is further reflected into the light guide 22, thereby serving the function of confining light and improving the light use efficiency. When the corner portion 22e is not chamfered and when the illumination device 13 is disposed such that the light emission surface 22b of the light guide 22 faces the reading target part of the original document 11, part of the light may be emitted in a direction significantly different from the reading target part of the original document 11. By chamfering the corner portion 22e, such an occurrence can be suppressed, which in turn is expected to improve the light use efficiency.

The form of the chamfered portion substantially facing the diffusion structures 26 is not limited, as long as the light confinement effect is expected to be improved, the line width of the linear illumination light emitted from the light emission surface 22b becomes smaller, and the irradiance in the center part of the irradiance distribution becomes larger. The form of the new side surface 22f created by chamfering may be an R chamfer (a curved surface), a C chamfer (flat surface), or a combination thereof. In other words, in a cross section of the light guide 22, the new side surface 22f may be a surface that substantially faces a diffusion structure 26, is in contact with the light emission surface 22b, and forms an angle exceeding 90 degrees with the light emission surface 22b. Such a new side surface 22f may be referred to as an “extended side surface”.

In a cross section of the light guide 22, a removal length c_{L}, which is a length of the extended side surface 22f in a direction parallel to the light emission surface 22b, at the light emission surface 22b may be 0.1×W₀′≤c_{L}≤0.3×W₀′, where W₀′ represents the width of the light emission surface 22b reduced by chamfering or the width of the light emission surface 22b when the extended side surface 22f is provided. An angle α_{c} between the extended side surface 22f and the light emission surface 22b may be 100 degrees to 160 degrees.

The extended side surface 22f created by chamfering may be colored with a color having a high light reflectance, such as white or silver, in order to improve the reflection efficiency of the arrived light. The white or silver coloring may be provided by printing or painting.

The illumination device 13 may include a structure covering the light guide 22. The light from the light source 23 incident on the light guide 22 propagates within the light guide 22 in the longitudinal direction. The light propagates while repeating reflection on the side surfaces of the light guide 22, as described previously. When the light that has reached a side surface of the light guide 22 satisfies the condition of total reflection in relation to the incidence angle with the side surface, almost 100% of the light is reflected, but if not, part of the light is emitted from the side surface of the light guide 22. Accordingly, in order to improve the light use efficiency, the illumination device 13 according to the present embodiment may include a light guide cover 24 that covers at least part of a side surface of the light guide 22. By providing the illumination device 13 with the light guide cover 24 for a side surface of the light guide 22, part of light emitted from the side surface of the light guide 22 is reflected on the inner surface of the light guide cover 24 and can be made to re-enter the light guide 22. As shown in the sectional view of FIG. 2, the light guide cover 24 may have a substantially U-shaped cross section perpendicular to the longitudinal direction (x-direction) and may be provided such that the inner surface of the light guide cover 24 and part of a side surface of the light guide 22 are in close contact with each other. Also, in order to increase the light reflectance, the inner surface of the light guide cover 24 may be colored with a highly light-reflective color, such as white or silver. The method of such coloring may be printing or painting. The light guide cover 24 may be made of plastic from the viewpoint of its formability and requests for lower price. Examples of the plastic used as the material for the light guide cover 24 include polyamides, polycarbonates, polyacetal, modified-polyphenyleneether, polybutylene terephthalate, polyphenylene sulfide, polyethersulfone, polyarylate, polyetherimide, and liquid crystal polymers. Also, from the viewpoint that the light guide cover 24 preferably has a color with a high light reflectance, the light guide cover 24 may be molded originally from white plastic, which may contain a white or silver pigment or dye.

With regard to examples of the light guide 22, illumination device 13, and contact image sensor 10 with various configurations and conditions, functions and effects thereof will be described, using simulation.

### First Example

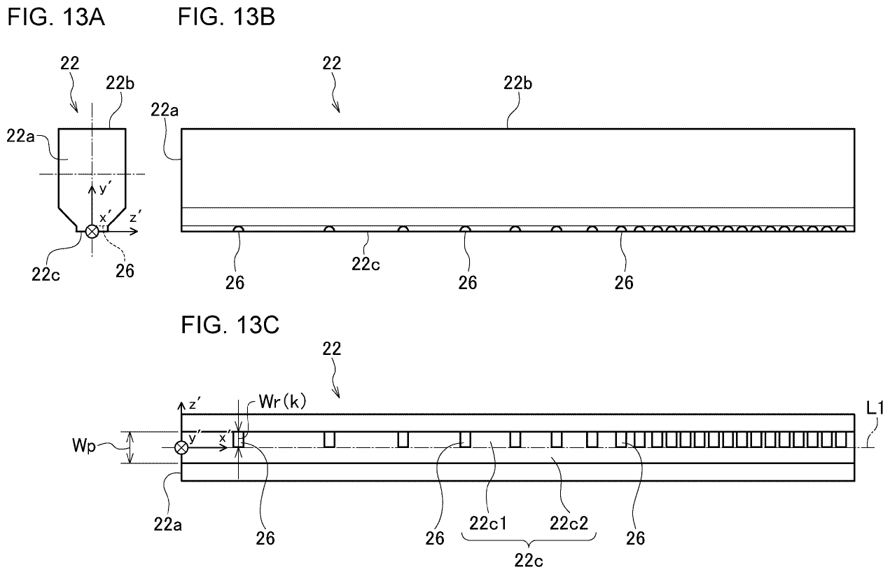

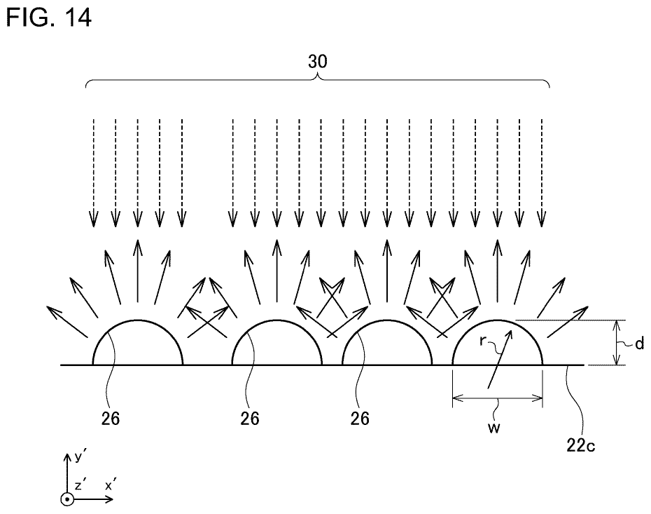

FIGS. 13A-13C constitute a schematic three-view drawing of the light guide 22 according to the first example. As shown in FIGS. 13A-13C, the light guide 22 according to the first example is rod-shaped and has a substantially rectangular cross section perpendicular to the longitudinal direction (x′-direction). It was assumed that, inside the light guide 22 according to the first example, an absorption coefficient α was 0.0011 [mm⁻¹] (internal transmittance=98.9%/10 mm) in the wavelength range of the light used, and Snell's law applied at an interface with air or the like. The refractive index of the light guide 22 was set to 1.48816. The light guide 22 according to the first example is a substantially rectangular prism of which the dimensions of an end surface, having substantially the same shape as the cross section perpendicular to the longitudinal direction, are 3.9 mm×2.5 mm and the length is 226 mm.

The light guide 22 according to the first example functionally includes the light emission surface 22b, side surfaces, and a light incidence surface 22a. The light incidence surface 22a is one end surface of the light guide 22 and is perpendicular to the light emission surface 22b and the side surfaces. The light guide 22 further includes the light reflecting surface 22c on a side surface facing the light emission surface 22b. The light emission surface 22b is a rectangle of 2.5 mm×226 mm, and the light reflecting surface 22c is a rectangle of 1.9 mm×226 mm. The light reflecting surface 22c and the light emission surface 22b are parallel and have a distance of 3.9 mm therebetween.

It was assumed that the light guide 22 according to the first example had a surface condition that would not cause scattering or diffuse reflection, unless otherwise described. Only for the description of the light guide 22, an x′y′z′ Cartesian coordinate system is set as shown in FIGS. 13A-13C. With the longitudinal direction of the light guide 22 set as the x′-direction, the x′-axis, which is parallel to the x′-direction and located on the light reflecting surface 22c and divides the light reflecting surface 22c into two parts, the origin, which is the intersection of the x′-axis and the end surface 22a, and the y′-axis, which is perpendicular to the light reflecting surface 22c and passes through the origin, are defined. The z′-axis, which is perpendicular to the x′-axis and the y′-axis and passes through the origin, is naturally defined. These axis notations and the center lines are used for illustration and are not shown on the actual light guide.

The light emission surface 22b is a surface specified by 0≤x′≤226, −2.5/2≤z′≤2.5/2, and y′=3.9, and the light reflecting surface 22c is a surface specified by 0≤x′≤226, −1.9/2≤z′≤1.9/2, and y′=0 (all units are in mm).

The light reflecting surface 22c of the light guide 22 according to the first example includes multiple diffusion structures 26 of groove shape. The diffusion structures 26 are arranged in the x′-direction at varied spacings. Such arrangement spacings and intervals were computationally optimized to emit light uniformly over the longitudinal direction of the emission surface of the light guide.

FIG. 14 is a schematic enlarged view of part of a group of groove-shaped diffusion structures viewed from the z′-direction. In FIG. 14, the trajectories of part of light traveling toward the diffusion structures 26 to reach them are indicated by dotted arrows 30. FIG. 14 schematically illustrates a state where the light is greatly diffused and reflected due to the slope of the curved surface of each diffusion structure 26. The structures 26 provided on the light reflecting surface 22c are referred to as “diffusion structures” or “diffusion surfaces” because these cause diffusive reflection as shown in FIG. 14. Although the present example shows the diffusion structures 26 of groove shape that each are constituted by a curved surface of part of a cylindrical side, it is suggested that the shape of each diffusion structure 26 is not specified as long as it is a concave shape that partially includes a slope for diffusing incident light when viewed from at least a cross section or a side surface of the light guide 22.

Each diffusion structure 26 provided on the light reflecting surface 22c of the light guide 22 according to the first example has a U-shaped concave structure and is constituted by part of a side surface of a cylinder with a radius r=0.40 mm. A width w in the x′-direction of a diffusion structure 26 is 0.71 mm. A depth d in the y′-direction of a diffusion structure 26 is 0.22 mm. The diffusion structures 26 are provided parallel to the z′-direction within the range of 0 mm≤z′≤1.9/2 mm. In the light reflecting surface 22c, when the range of 0 mm≤z′≤1.9/2 mm is set as the first reflecting surface 22c1 and the range of −1.9/2 mm≤z′≤0 mm is set as the second reflecting surface 22c2 with the x′-axis dividing the light reflecting surface 22c into two parts as the boundary, the diffusion structures 26 are formed only on the first reflecting surface 22c1. In other words, the light guide 22 according to the first example includes, on the light reflecting surface 22c, diffusion structures 26 that each have a length reaching ½ of the width of the light reflecting surface 22c from an end in a width direction of the light reflecting surface 22c. Also, with regard to the arrangement of the diffusion structures 26 over the x′-direction, or arrangement spacing of the diffusion structures 26, the diffusion structures 26 are arranged so as to make the irradiance distribution of the linear light rays emitted from the light emission surface 22b uniform in the x′-direction (longitudinal direction). In general, the diffusion structures 26 are arranged at relatively large intervals in an area closer to the light source 23 and arranged at relatively small intervals in an area farther from the light source 23.

### Second Example

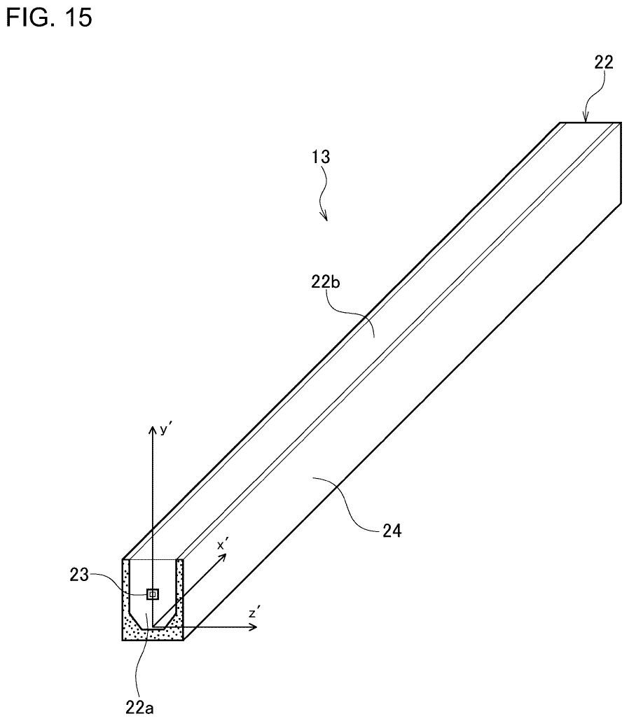

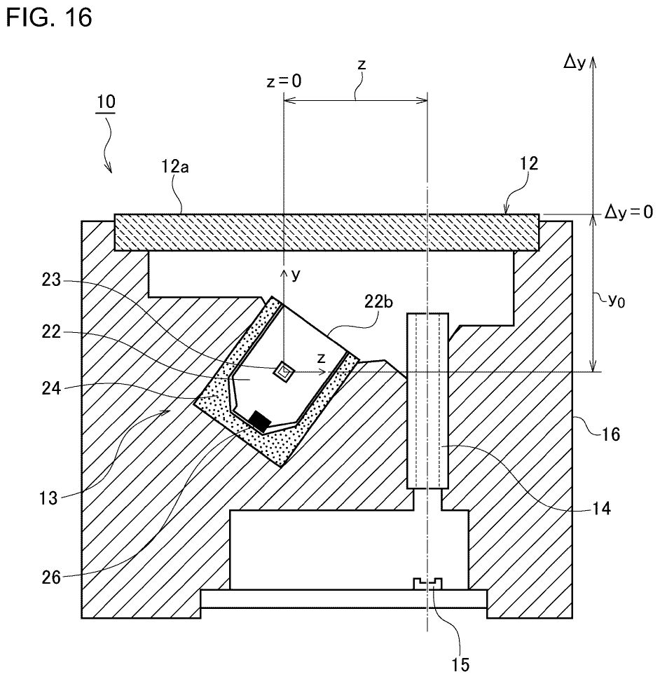

FIG. 15 shows the illumination device 13 according to the second example. The illumination device 13 according to the second example includes the light guide 22 according to the first example. For the description of the illumination device 13, the x′y′z′ Cartesian coordinate system used in the description of the light guide 22 is used.

In the illumination device 13 according to the second example, the light source 23 is disposed on one end surface 22a of the light guide 22. The light source 23 has a rectangular shape of which the size of the light emitting surface is 0.25 mm×0.25 mm, and its orientation attribute is Lambertian light distribution. Lambertian light distribution is a light distribution pattern in which the luminous intensity in the direction of an angle θ° can be expressed as cos θ times the luminous intensity Io on the optical axis (θ=0°) (the angle at which the luminous intensity is half the luminous intensity Io on the optical axis can be calculated as θ=60° from cos θ=0.5). As the light source 23, an LED was assumed. The center of the light emitting surface of the light source 23 is located at (−0.4, 1.9, 0) in the x′y′z′ Cartesian coordinate system (all units are in mm). In a simulation for clarifying the function of the illumination device 13, 5×10⁶ rays were emitted from the light source, and all the rays entered the light guide 22 from the light incidence surface 22a. The distance between the light source 23 and the light incidence surface 22a of the light guide 22 was set to 0.4 mm, and Fresnel reflection by the light incidence surface 22a was not considered. Also, in the simulation, the wavelength of the light source 23 was set to 550 nm, the effect of refractive index dispersion of the light guide 22 and other media was not considered, and it was assumed that all unpolarized light would be emitted. In order to drive an LED, an electrical circuit such as a driver and a power supply are normally required, and a printed wiring board or the like for electrical connection to the LED chip is essential. However, these are omitted in the calculations and description of the second example.

The illumination device 13 according to the second example includes the light guide cover 24 that covers a side surface of the light guide 22. The light guide cover 24, including the inner surface facing a side surface of the light guide 22, was assumed to be made from white plastic. The inner surface of the light guide cover 24 was assumed to be a Lambertian reflecting surface of which radiation intensity would follow Lambert's cosine law. The reflectance of the inner surface of the light guide cover 24 was set to 87% (absorptance 13%). FIG. 15 shows an end surface of the light guide cover 24 perpendicular to the x′-direction. The light guide cover 24 has a cross section of substantially U-shape.

### Third Example

FIG. 16 is a schematic sectional view perpendicular to the longitudinal direction of the contact image sensor 10 according to the third example. The contact image sensor 10 according to the third example includes the illumination device 13 according to the second example. In the third example, the diffusion structures 26 on the light reflecting surface of the light guide 22 are arranged so as to be closer to the document reading position.

The contact image sensor 10 according to the third example includes the document table 12 on which an original document including an image reading target part is placed, the light receiving element array 15 arranged in the longitudinal direction, and the erecting equal-magnification lens array 14 that condenses an image to be read onto the light receiving element array 15. Further, in the contact image sensor 10 according to the third example, the illumination device 13 according to the second example for illuminating the image reading target part is disposed such that the light emission surface 22b substantially faces the image reading target part.

A Cartesian coordinate system used to describe the function of the contact image sensor 10 is considered here. With the center of the light source 23 in the illumination device 13 according to the second example set as the origin, the x-axis passing through the origin and parallel to the longitudinal direction (the direction perpendicular to the drawing surface), the z-axis passing through the origin, parallel to a document placement surface 12a of the document table 12, and perpendicular to the x-axis, and the y-axis passing through the origin and perpendicular to the x-axis and the z-axis are defined. Also, in a cross section of the contact image sensor 10, the angle between the normal of the light emission surface 22b and the z-axis or the x-z plane was set to 40 degrees.

With the illumination device 13 according to the second example driven under the above conditions, the amount of radiation, such as irradiance, in the image reading target part (hereinafter, referred to as the “reading position”) and in the vicinity of the reading position was obtained by simulation. In FIG. 16, the irradiance was calculated while z was increased from the reading position (y, z)=(6.4, 0) on the document table 12; thereafter, the irradiance was calculated while z was increased from the reading position (y, z)=(6.4+1, 0) on the document table 12; thereafter, the irradiance was calculated while z was increased from the reading position (y, z)=(6.4+2, 0) on the document table 12; and thereafter, the irradiance was calculated while z was increased from the reading position (y, z)=(6.4+3, 0) on the document table (all units are in mm). The value of the irradiance was obtained by averaging the irradiance in the range of x=100 mm to 150 mm in the length of the light guide 22, i.e., 226 mm. Thus, the y- and z-dependence of the irradiance at the reading position and in the vicinity thereof was obtained by simulation.

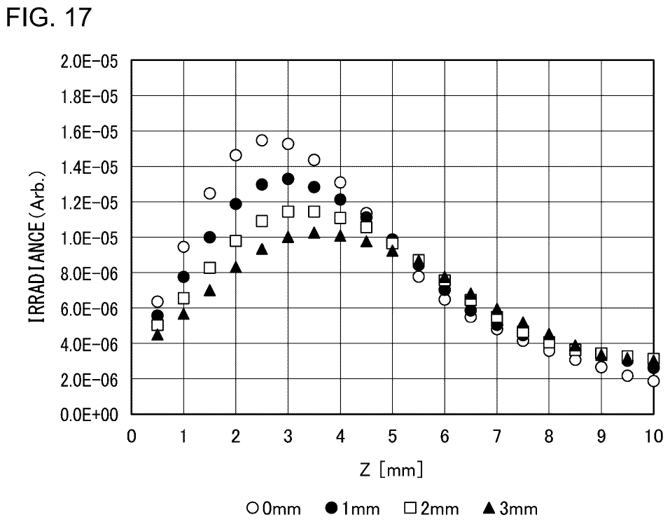

FIG. 17 shows relationships between the y-dependence and z-dependence of the irradiance at the reading position and in the vicinity thereof. In FIG. 17, it can be seen that there is a singularity of z where the change in irradiance is smallest while Δy varies in the range of 0 to 3 mm. When this z-singularity is defined as z₀, z₀ is 4.9 mm in the contact image sensor 10 according to the third example. Changing Δy in the range of 0 to 3 mm means that the reading object is moved away from the document table 12 by the amount, that is, “floating of the document occurs”. It can be said that, by setting the distance in the z-direction between the illumination device 13 and the reading position to z₀ (4.9 mm), even when the original document comes off from the document table 12, there is little change in the irradiance of the illumination light illuminating the image to be read. Further, this z-singularity z₀ may be a position where the DOI is minimized. The DOI is defined as the depth of illumination or the depth of irradiance, which can be said to be a very important factor in the process of designing a contact image sensor with a predetermined illumination device.

Also, with reference to FIG. 17, in the contact image sensor 10 according to the third example, an average value of the irradiance at the z-singularity z₀ among the cases of Δy=0 to 3 mm was 9.95×10⁻⁶.

### Fourth Example

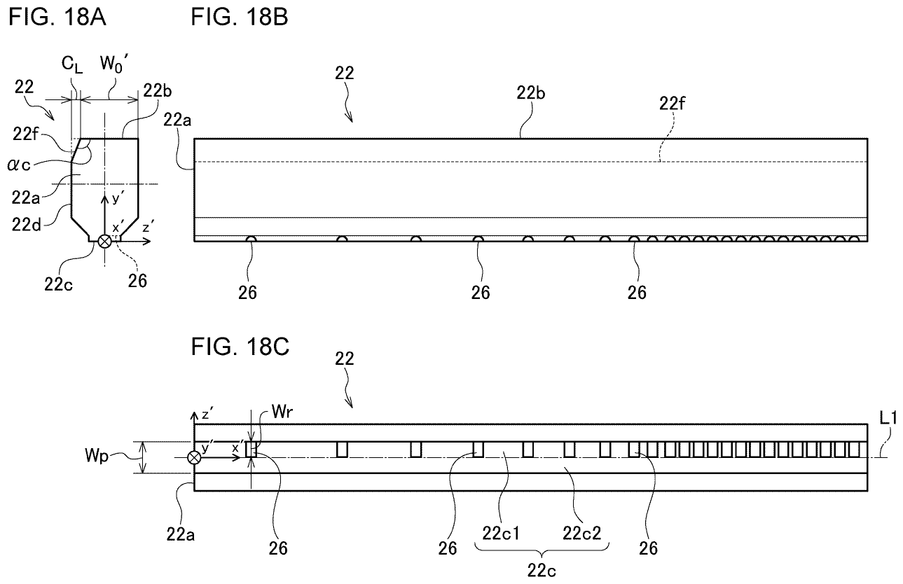

FIGS. 18A-18C constitute a schematic three-view drawing of the light guide 22 according to the fourth example. As shown in FIG. 18A, the light guide 22 according to the fourth example has a form in which C-chamfering has been performed on a corner portion substantially facing the diffusion structures 26, so that one side surface is added compared to the light guide 22 according to the first example. In a cross section of the light guide 22 according to the fourth example, the length c_{L} corresponding to the removed light emission surface 22b is 0.4 mm, and the angle dc between the new side surface 22f and the light emission surface 22b is 150 degrees. The new side surface 22f provided by C-chamfering is a rectangle of 0.81 mm×226 mm, and the surface attributes thereof are made same as the other side surfaces of the light guide 22. The light guide 22 according to the fourth example has the same structure, properties, and parameters as the light guide 22 according to the first example, except that C-chamfering has been performed in the longitudinal direction on the corner portion substantially facing a diffusion structure 26 in a cross section.

### Fifth Example

The illumination device 13 according to the fifth example includes the light guide 22 according to the fourth example. The illumination device 13 according to the fifth example has the same structure, properties, and parameters as the illumination device 13 according to the second example, except that the light guide 22 according to the fourth example is used instead of the light guide 22 according to the first example. Although the illumination device 13 according to the fifth example is not illustrated, it is almost the same in appearance as the illumination device shown in FIG. 15.

### Sixth Example

The contact image sensor according to the sixth example includes the light guide 22 according to the fourth example and the illumination device according to the fifth example. In the sixth example, the illumination device 13 is disposed so that the diffusion structures 26 on the light reflecting surface 22c are closer to the document reading position, and the extended side surface 22f substantially facing the diffusion structures 26 is farther from the document reading position. The structure, properties, and parameters are the same as those of the contact image sensor 10 according to the third example, except that the light guide 22 according to the fourth example is used instead of the light guide 22 according to the first example.

As in the contact image sensor 10 according to the third example, an xyz Cartesian coordinate system was set in the contact image sensor 10 according to the sixth example, and the y- and z-dependence of the irradiance at the reading position and in the vicinity thereof was obtained by simulation.

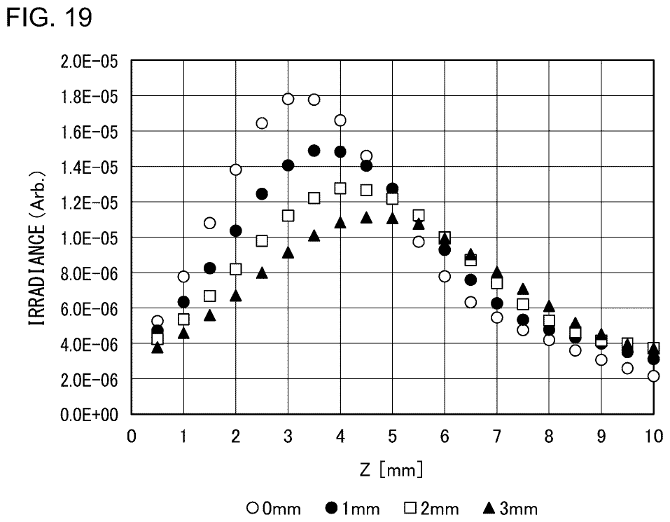

FIG. 19 shows relationships between the y-dependence and z-dependence of irradiance at the reading position and in the vicinity thereof. In FIG. 19, the z-singularity z₀, where the change in irradiance is smallest while Δy varies in the range of 0 to 3 mm, is 5.0 mm in the contact image sensor 10 according to the six example. Also, with reference to FIG. 19, in the contact image sensor 10 according to the six example, an average value of the irradiance at the z-singularity z₀ among the cases of Δy=0 to 3 mm was 11.9×10⁻⁶.

### First Comparative Example

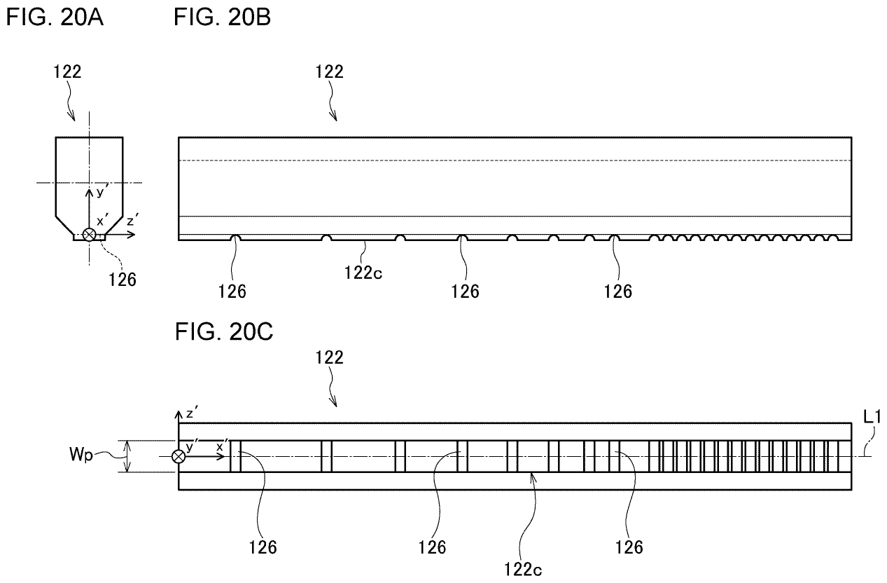

FIGS. 20A-20C constitute a schematic three-view drawing of a light guide 122 according to the first comparative example. The light guide 122 according to the first comparative example has the same structure as the light guide 22 according to the first example, except that diffusion structures 126 of groove shape that each include a shape of a cylindrical side are provided over the entire width in the z′-direction of a light reflecting surface 122c, that the radius of the cylinder constituting each diffusion structure 126 is 0.203 mm, and that the arrangement of the diffusion structures 126 of groove shape in the x′-direction was determined so as to substantially equalize the irradiance on the light emission surface.

### Second Comparative Example

An illumination device according to the second comparative example has the same structure, properties, and parameters as the illumination device 13 according to the second example, except that the light guide 122 according to the first comparative example is provided instead of the light guide 22 according to the first example.

### Third Comparative Example

A contact image sensor according to the third comparative example has the same structure, properties, and parameters as the contact image sensor 10 according to the third example, except that the illumination device according to the second comparative example is provided instead of the illumination device 13 according to the second example.

As in the contact image sensor 10 according to the third example, an xyz Cartesian coordinate system was set in the contact image sensor according to the third comparative example, and the y- and z-dependence of the irradiance at the reading position and in the vicinity thereof was obtained by simulation.

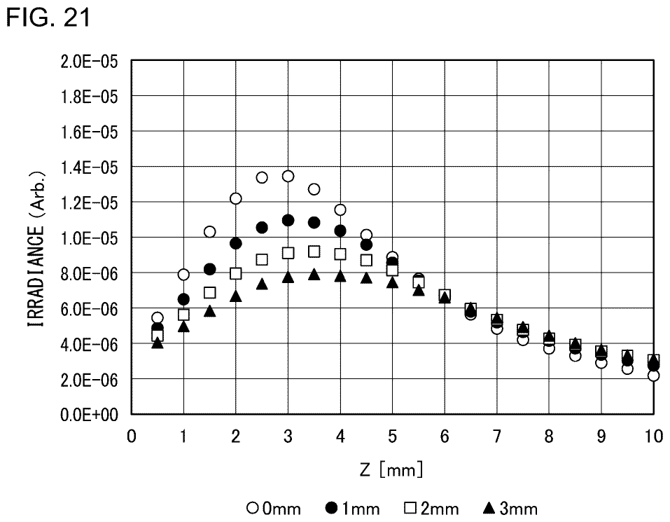

FIG. 21 shows relationships between the y-dependence and z-dependence of irradiance at the reading position and in the vicinity thereof. In FIG. 21, the z-singularity z₀, where the amount of change in irradiance is smallest while Δy varies in the range of 0 to 3 mm, is 6.0 mm in the contact image sensor according to the third comparative example. Also, with reference to FIG. 21, in the contact image sensor according to the third comparative example, an average value of the irradiance at the z-singularity z₀ among the cases of Δy=0 to 3 mm was 6.62×10⁻⁶.

With reference to FIGS. 17, 19, and 21, the contact image sensors 10 according to the third example and the sixth example are compared to the contact image sensor according to the third comparative example. As described previously, FIGS. 17, 19, and 21 are graphs regarding the contact image sensors according to the third example, the sixth example, and the third comparative example, respectively, which each show the y-dependence and z-dependence of irradiance in the vicinity of the reading position. In the relationships shown in each graph, the maximum value of irradiance when Δy is 0 mm, i.e., at the position in contact with the surface of the document table 12 (with no floating of the document), is 1.60×10⁻⁶ (z_{M}=2.45 mm, where z_{M} is a z-value corresponding to the maximum irradiance), 1.80×10⁻⁶ (z_{M}=2.95 mm), and 1.30×10⁻⁶ (z_{M}=2.95 mm) in the order of the contact image sensor according to the third example, that according to the sixth example, and that according to the third comparative example. The ratio among the maximum values of irradiance is 1.23:1.38:1.

Also, the absolute value Δz of the difference between z_{M}, which is a z-value corresponding to the maximum value of irradiance, and the z-singularity z₀, i.e., Δz=|z_{M}−z₀|, is 2.45 mm, 2.05 mm, and 3.05 mm in the order of the contact image sensor according to the third example, that according to the sixth example, and that according to the third comparative example.

These results show that, in the order of the contact image sensor according to the third comparative example, that according to the third example, and that according to the sixth example, the maximum value of irradiance increases, and the value of Δz decreases. Accordingly, with regard to the contact image sensors according to the third example and the sixth example, even when Δy varies in the range of 0 to 4 mm (with floating of the document), the amount of radiation such as irradiance of the light illuminating the original document can be made relatively large.

In a contact image sensor, when a direction parallel to the surface of the document table and perpendicular to a longitudinal direction is defined as a z-direction, a direction perpendicular to the z-direction and the surface of the document table is defined as a y-direction, a position in the z-direction at which the change in irradiance is smallest within the range of 0 to 4 mm in the y-direction from the surface of the document table is defined as z₀, and a position in the z-direction at which the irradiance on the surface of the document table is maximum is defined as z_{M}, it is preferable that Δz=|z₀−z_{M}|≤2.5 [mm] holds.

The present disclosure has been described with reference to embodiments. The embodiments are intended to be illustrative only, and it will be obvious to those skilled in the art that various modifications to a combination of constituting elements or processes in the embodiments could be developed and that such modifications also fall within the scope of the present disclosure.

What is claimed is:

1. A light guide that propagates, in a longitudinal direction, light incident on an end surface thereof while reflecting the light on an inner surface and emits the light from a light emission surface, the light guide comprising:
a light reflecting surface substantially facing the light emission surface; and
a plurality of diffusion structures provided on the light reflecting surface to diffuse and reflect light,
wherein, when the light reflecting surface is divided into two regions and when one region is defined as a first reflecting surface while the other region is defined as a second reflecting surface, Vp2≤Vp1 holds, where Vp1 is the volume of part of a diffusion structure located in the first reflecting surface, and Vp2 is the volume of part of the diffusion structure located in the second reflecting surface.

2. The light guide according to claim 1, wherein each of the diffusion structures includes part of a shape of a side surface of a cylinder or part of a spherical surface.

3. The light guide according to claim 1, wherein Vp2=0 holds.

4. The light guide according to claim 1, including a chamfer connecting to the light emission surface, on a cross section perpendicular to the longitudinal direction.

5. The light guide according to claim 4, wherein an angle α_{c} between the chamfer and the light emission surface on a cross section perpendicular to the longitudinal direction is 100 degrees to 160 degrees.

6. An illumination device, comprising:
the light guide according to claim 1; and
a light source disposed on the end surface or in the vicinity of the end surface so that light enters the light guide from the end surface.

7. An illumination device, comprising:
the light guide according to claim 4; and
a light source disposed on the end surface or in the vicinity of the end surface so that light enters the light guide from the end surface.

8. A contact image sensor, comprising:
a document table;
the illumination device according to claim 6 used to illustrate an original document placed on the document table;
a lens array that condenses reflected light from part of the original document illustrated by the illumination device; and
a light receiving element array that receives light condensed by the lens array.

9. A contact image sensor, comprising:
a document table;
the illumination device according to claim 7 used to illustrate an original document placed on the document table;
a lens array that condenses reflected light from part of the original document illustrated by the illumination device; and
a light receiving element array that receives light condensed by the lens array.

10. The contact image sensor according to claim 8, wherein the illumination device is disposed such that the diffusion structures are closer to a reading position of the original document, on a cross section perpendicular to a longitudinal direction of the contact image sensor.

11. The contact image sensor according to claim 9, wherein the illumination device is disposed such that the diffusion structures are closer to a reading position of the original document, on a cross section perpendicular to a longitudinal direction of the contact image sensor.

12. The contact image sensor according to claim 8, wherein, when a direction parallel to a surface of the document table and perpendicular to the longitudinal direction is defined as a z-direction, a direction perpendicular to the z-direction and the surface of the document table is defined as a y-direction, a position in the z-direction at which a change in irradiance is smallest within a range of 0 to 4 mm in the y-direction from the surface of the document table is defined as z₀, and a position in the z-direction at which the irradiance on the surface of the document table is maximum is defined as z_{M}, |z_{M}−z₀|≤2.5 mm holds.

13. The contact image sensor according to claim 9, wherein, when a direction parallel to a surface of the document table and perpendicular to the longitudinal direction is defined as a z-direction, a direction perpendicular to the z-direction and the surface of the document table is defined as a y-direction, a position in the z-direction at which a change in irradiance is smallest within a range of 0 to 4 mm in the y-direction from the surface of the document table is defined as z₀, and a position in the z-direction at which the irradiance on the surface of the document table is maximum is defined as z_{M}, |z_{M}−z₀|≤2.5 mm holds.
